(19) United States
(12) Patent Application Publication
(10) Pub. No.: US 2012/0083553 A1
(43) Pub. Date: Apr. 5, 2012

(54) Molded Articles For Electric Vehicle Parts

(75) Inventors: Sei Wakatsuka, Shizuoka (JP); Nobuyuki Sueyasu, Shizuoka (JP)

(73) Assignee: Win-Tech Polymer Ltd., Tokyo (JP)

(21) Appl. No.: 13/375,349

(22) PCT Filed: Jun. 2, 2010
(86) PCT No.: PCT/JP2010/059355

§ 371 Date: Nov. 30, 2011

(30) Foreign Application Priority Data
Jun. 3, 2009 (JP) 2009-134505

(51) Int. Cl. C08L 63/00; C08K 5/3492; C08K 5/53

(52) U.S. Cl. 523/451; 524/126; 524/133; 524/101; 524/100

(57) ABSTRACT

A molded article for an electric vehicle part is provided using a thermoplastic polyester resin composition imparting excellent hydrolysis resistance, electric insulation, flame retardance, and tracking resistance. The molded article for an electric vehicle part is formed by molding the thermoplastic polyester resin composition including a thermoplastic polyester resin, which has a terminal carboxyl group amount that is no more than 30 meq/kg, and a flame retardant, in which the tracking resistance measured according to IEC 112, the third edition, after pressurized heat treatment with the 120° C. saturated steam for 200 hours is no less than 500 V, and in which the volume resistivity value measured after the pressurized heating treatment with the 120° C. saturated steam for 200 hours is no less than 1×1015 Ω·m.

### TECHNICAL FIELD

The present invention relates to molded articles for electric vehicle parts having superior hydrolysis resistance, electric insulation, flame retardance, and tracking resistance.

### BACKGROUND ART

Thermoplastic polyester resins have excellent mechanical properties, electrical properties, heat resistance, weather resistance, moisture resistance, chemical resistance and solvent resistance, and have been widely used in vehicle parts, electrical and electronic components, and the like. In addition, with expanding fields of application of such thermoplastic polyester resins, superior flame retardance and durability have been demanded for safety reasons.

A variety of methods have been proposed in order to impart flame retardance and durability to thermoplastic polyester resins. For example, adding a halogen flame retardant (halogen compound, antimony compound, or the like), or non-halogen flame retardant (phosphorus compound, nitrogen-containing compound, or the like) is known as a method of imparting flame retardance to thermoplastic polyester resins. In addition, also adding talc or glass fiber is known as a method of improving the electrical properties such as tracking resistance.

Moreover, several proposals have been made also for thermoplastic polyester resin compositions allowing multiple properties to coexist. For example, in Patent Document 1, a composition in which talc, halogenized phenylalkyl(meth)acrylate flame retardant and olefinic elastomer are mixed into a thermoplastic polyester resin is disclosed as a composition improving flame retardance, tracking resistance and flowability. In addition, Patent Document 2 discloses a composition in which a phosphinic acid salt and/or diphosphinic acid salt, and/or polymer thereof, a salt of a triazine compound and cyanuric acid or isocyanuric acid, and a boric acid metal salt are mixed into a thermoplastic polyester resin as a composition superior in flame retardance, mechanical properties, molding processability, tracking resistance, and the like.

However, high reliability is demanded in articles in the automotive field to ensure safety, and in particular, there are many articles operating at high voltage in electric vehicles, and it being difficult to ignite when an abnormality arises and difficult for fire to spread even if ignited are important matters. Therefore, molded articles made by molding the above such compositions having flame retardance, tracking resistance and the like is suited for a case that stores articles for an electric vehicle.

However, since thermoplastic polyester resins have many ester bonds, they have a characteristic of tending to undergo hydrolysis. As a result, molded articles using thermoplastic polyester resin have a weakness in which the electrical insulation properties such as the volume resistivity value decline as a result of hydrolysis. For a case storing articles for an electric vehicle, it has been demanded to have excellent hydrolysis resistance even under high moisture environments to maintain the electrical insulation property.

The hydrolysis resistance of conventional thermoplastic polyester resin compositions has been reviewed up to now. For example, in Patent Document 3, a polybutylene terephthalate resin composition is disclosed that maintains flexibility and the like even after moist heat treatment. In addition, in Patent Document 4, a thermoplastic polyester resin composition is disclosed that maintains specific physical properties after moist heat treatment.

As stated above, thermoplastic polyester resin compositions that can maintain physical properties after moist heat treatment have been disclosed. However, in order to more preferably use a thermoplastic polyester resin composition in a case that stores articles for an electric vehicle, it has been demanded that the electrical insulation properties such as the volume resistivity value be further raised, and that the electrical insulation properties such as the volume resistivity value be adequately maintained after moist heat treatment.

Patent Document 1: Japanese Unexamined Patent Application, Publication No, H10-158487

### Patent Document 2: Japanese Unexamined Patent Application, Publication Nor 2006-117722

### Patent Document 3: Japanese Unexamined Patent Application, Publication No. 2008-156392

### Patent Document 4: Japanese Unexamined Patent Application, Publication No. 2003-342482

### DISCLOSURE OF THE INVENTION

### Problems to be Solved by the Invention

The present invention has been made in order to solve the above such problems, and an object thereof is to provide a molded article for an electric vehicle part using a thermoplastic polyester resin composition imparting excellent hydrolysis resistance, electric insulation, flame retardance, and tracking resistance.

### Means for Solving the Problems

As a result of thoroughly researching to achieve the above-mentioned object, the present inventors found that a molded article of an electric vehicle part using a composition containing a thermoplastic polyester resin and a flame retardant has excellent flame retardance and tracking resistance, while also possessing excellent electrical insulation properties. More specifically, the present invention provides the following.

According to a first aspect of the present invention, a molded article for an electric vehicle part formed by molding a thermoplastic polyester resin composition, includes a thermoplastic polyester resin, having a terminal carboxyl group amount that is no more than 30 meq/kg, and a flame retardant, in which the tracking resistance measured according to IEC112, the third edition, after pressurized heat treatment with the 120° C. saturated steam for 200 hours is at least 500 V, and the volume resistivity value measured after the pressurized heat treatment with the 120° C. saturated steam for 200 hours is no less than 1×10¹⁵ Ω·m.

According to a second aspect of the present invention, in the molded article for an electric vehicle part as described in the first aspect, the flame retardant is phosphinic acid salt and/or diphosphinic acid salt, and is contained in an amount of 10 to 100 parts by mass relative to 100 parts by mass of the thermoplastic polyester resin.

According to a third aspect of the present invention, in the molded article for an electric vehicle part as described in the second aspect, the phosphinic acid salt is represented by the following general formula (1), and the diphosphinic acid salt is represented by the following general formula (2).

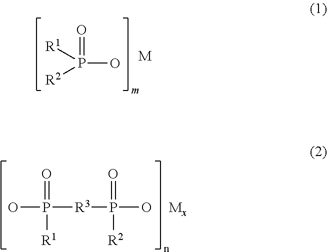

(In the formulae, R¹ and R² are a linear or branched C₁ to C₆-alkyl group which may contain a phenyl group, hydrogen or one hydroxyl group, R³ is a linear or branched C₁˜C₁₀-alkylene group, arylene group, alkylarylene group or arylalkylene group; M is an alkaline earth metal, alkaline metal, Zn, Al, Fe or boron; m is an integer of 1 to 3; n is an integer of 1 or 3; and x is 1 or 2.)

According to a fourth aspect of the present invention, the molded article for an electric vehicle part as described in the second or third aspect further includes 1 to 50 parts by mass of a salt of a triazine-derived compound and cyanuric acid or isocyanuric acid and/or a double salt of an amino-group-containing nitrogen compound and polyphosphoric acid, as a nitrogen-derived flame retardant, relative to 100 parts by mass of the thermoplastic polyester resin,

According to a fifth aspect of the present invention, the molded article for an electric vehicle part as described in the first aspect further includes 30 to 100 parts by mass of talc relative to 100 parts by mass of the thermoplastic polyester resin.

According to a sixth aspect of the present invention, in the molded article for an electric vehicle part as described in the fifth aspect, the flame retardant is at least one kind selected from the group consisting of a brominated flame retardant, phosphorus-derived flame retardant, antimony-derived flame retardant and nitrogen-derived flame retardant.

In the molded article for an electric vehicle part as described in the fifth or sixth aspect, the talc has an average particle diameter of 0.04 to 10 μm and a bulk specific gravity of 0.4 to 1.5.

According to an eighth aspect of the present invention, in the molded article for an electric vehicle part as described in any one of the fifth to seventh aspects, the molded article further comprises 5 to 50 parts by mass of an olefinic elastomer relative to 100 parts by mass of the thermoplastic polyester resin.

According to a ninth aspect of the present invention, in the molded article for an electric vehicle part as described in any one of the first to eighth aspects, the thermoplastic polyester resin is a polybutylene terephthalate resin, modified polybutylene terephthalate resin, polyethylene terephthalate resin, modified polyethylene terephthalate resin, or a mixture thereof.

According to a tenth aspect of the present invention, the molded article for an electric vehicle part as described in any one of the first to ninth aspects further includes a filler in an amount of no more than 200 parts by mass relative to 100 parts by mass of the thermoplastic polyester resin.

According to an eleventh aspect of the present invention, the molded article for an electric vehicle part as described in any one of the first to tenth aspects further includes 0.1 to 50 parts by mass of tetrafluoro-ethylene polymer relative to 100 parts by mass of the thermoplastic polyester resin.

According to a twelfth aspect of the present invention, the molded article for an electric vehicle part as described in any one of the first to eleventh aspects further includes 0.1 to 10 parts by mass of an epoxy compound and/or a carbodiimide compound relative to 100 parts by mass of the thermoplastic polyester resin.

According to a thirteenth aspect of the present invention, in the molded article for an electric vehicle part as described in any one of the first to twelfth aspects, the molded article is a case that stores the electric vehicle part.

### EFFECTS OF THE INVENTION

The molded article for an electric vehicle part of the present invention has excellent flame retardance and tracking resistance, while having excellent electric insulation, and thus is particularly suited to a case that stores a part for an electric vehicle.

### PREFERRED MODE FOR CARRYING OUT THE INVENTION

Hereinafter, embodiments of the present invention will be explained in detail.

The present invention relates to electric vehicle parts made by molding a thermoplastic polyester resin composition.

The molded article for an electric vehicle part of the present invention includes a thermoplastic polyester resin and a flame retardant, in which a tracking resistance measured according to IEC112, third edition, after pressure cooker treatment with 120° C. saturated steam for 200 hours is at least 500 V, and the volume resistivity value measured after the pressure cooker treatment with 120° C. saturated steam for 200 hours is no less than 1×10¹⁵ Ω·m. The molded article for an electric vehicle part of the present invention is a case that stores an electric vehicle part made by molding the above-mentioned thermoplastic polyester resin composition.

Hereinafter, the thermoplastic polyester resin composition and the case will be explained in order.

### Thermoplastic Polyester Resin Composition

So long as the thermoplastic polyester resin composition used in the present invention is a thermoplastic polyester resin composition having the above such properties, the type of components for the thermoplastic polyester resin, flame retardant, and the like to be used are not particularly limited, and conventional, well-known components can be used. In addition, the content of each component is not limited either, and are adjusted as appropriate so as to satisfy the above-mentioned properties. The following such thermoplastic polyester resin compositions can be exemplified as the above such thermoplastic polyester resin composition.

As one example of the thermoplastic polyester resin composition used in the present invention, a thermoplastic polyester resin composition in which the flame retardant is phosphinic acid salt and/or disphosphinic acid salt, and containing 10 to 100 parts by mass of the above-mentioned flame retardant relative to 100 parts by mass of thermoplastic polyester resin (hereinafter may be referred to as “flame retardant containing phosphorus-based flame retardant”) can be exemplified.

In addition, as another example of the thermoplastic polyester resin composition used in the present invention, a thermoplastic polyester resin composition containing a flame retardant, and further containing 30 to 100 parts by mass of talc relative to 100 parts by mass of thermoplastic polyester resin (hereinafter may be referred tows “resin composition containing talc”) can be exemplified.

Hereinafter, these thermoplastic polyester resin compositions will be explained in further detail. First, the former thermoplastic polyester resin composition in which the flame retardant is phosphinic acid salt and/or disphosphinic acid salt, and containing 10 to 100 parts by mass of the above-mentioned flame retardant relative to 100 parts by mass of thermoplastic polyester resin will be explained.

### Resin Composition Containing Phosphorus-Based Flame Retardant

A thermoplastic polyester resin, phosphinic acid salt and/or disphosphinic acid salt are contained in the resin composition containing a phosphorus-based flame retardant.

### Thermoplastic Polyester Resin

The thermoplastic polyester resin contained in the resin composition containing a phosphorus-based flame retardant used in the present invention is a polyester resin obtained by polycondensation of an dicarboxylic acid compound and dihydroxy compound, polycondensation of an oxycarboxylic acid compound, polycondensation of these three component compounds, or the like. Any homopolyester or copolyester can be used in the present invention.

The dicarboxylic acid compound constituting the thermoplastic polyester resin to be used herein, for example, is a well known dicarboxylic acid compound such as terephthalic acid, isophthalic acid, naphthalenedicarboxylic acid, diphenyl carboxylic acid, diphenyl ether dicarboxylic acid, diphenyl ethane dicarboxylic acid, cyclohexanedicarboxlic acid, adipic acid and sebacic acid, and alkyls, alkoxys or halogen substituted products of these, etc. In addition, these dicarboxylic acid compounds can also be used in polymerization in the form of an ester formable derivative, e.g., a lower alcohol ester such as dimethyl ester.

The dihydroxy compound, for example, is a dihydroxy compound such as ethylene glycol, propylene glycol, butanediol, neopentyl glycol, hydroquinone, resorcin, dihydroxyphenyl, naphthalenediol, dihydroxy diphenyl ether, cyclohexanediol, 2,2-bis(4-hydroxyphenyl)propane and di-ethoxylated bisphenol A; polyoxyalkylene glycol, and alkyls, alkoxys or halogen substituted products of these, etc., and can be used singly or by mixing two or more thereof.

As the oxycarboxylic acid, for example, an oxycarboxylic acid such as oxybenzoic acid, oxynaphthoic acid and diphenylene oxycarboxylic acid, and alkyls, alkoxys or halogen substituted products of these can be exemplified. In addition, ester formable derivatives of these compounds can also be used. One, two or more of these compounds are used in the present invention.

Moreover, in addition to these, it may be a polyester having a branched or bridged structure in which a small amount of a trifunctional monomer, i.e. trimellitic acid, trimesic acid, pyromellitic acid, pentaerythritol, trimethylolpropane, or the like, is used jointly.

The thermoplastic polyester resin generated by polycondensation with the above-mentioned compound or the like as a monomer component can be used as a component of the resin composition used in any aspect of the present invention. Although these compounds are used independently or by mixing two or more, it is preferable to use polyalkyleneterephthalate resin, and it is more preferable to use a copolymer with polybutylene terephthalate resin and/or polyethylene terephthalate resin as main components (modified polyethylene terephthalate resin). In addition, the thermoplastic polyester resin of the present invention may be modified by a well-known method of cross-linking, graft polymerization, or the like,

As the thermoplastic polyester resin contained in the resin composition containing the above-mentioned phosphorus-based flame retardant, polybutylene terephthalate resin, modified polybutylene terephthalate resin, polyethylene terephthalate resin, modified polyethylene terephthalate resin, or a mixture of these is preferable. Among these, polybutylene terephthalate resin and modified polyethylene terephthalate resin are particularly preferable.

For the thermoplastic polyester resin contained in the resin composition containing the above-mentioned phosphorus-based flame retardant, a thermoplastic polyester resin having an amount of terminal carboxyl groups of no more than 30 meq/kg, and preferably no more than 25 meq/kg, is used. So long as amount of terminal carboxyl groups is no more than 30 meq/kg, a decline in the electric property due to hydrolysis under a moist heat environment can be considerably suppressed.

The amount of terminal carboxyl groups can be measured by dissolving a pulverized sample of polybutylene terephthalate for 10 minutes at 215° C. in benzyl alcohol, and then titrating with a 0.01 N sodium hydroxide aqueous solution.

For the thermoplastic polyester resin contained in the resin composition containing the above-mentioned phosphorus-derived flame retardant, that having an intrinsic viscosity of 0.5 to 1.3 dl/g can be used. From the point of moldability and mechanical properties, that in the range of 0.65 to 1.15 dl/g is preferable. By blending thermoplastic polyester resins having different intrinsic viscosities, e.g., by blending a thermoplastic polyester resin with an intrinsic viscosity of 1.2 dl/g and a thermoplastic polyester resin with an intrinsic viscosity of 0.8 dl/g, an intrinsic viscosity of 1.0 dl/g may be realized. It should be noted that the intrinsic viscosity (IV) can be measured under conditions with a temperature of 35° C. in o-chlorophenol. When using a thermoplastic polyester resin having an intrinsic viscosity in such a range, it becomes easy to efficiently realize the imparting of sufficient toughness and reduction in melt viscosity. If the intrinsic viscosity is too high, the melt viscosity during molding will rise, and depending on the case, there is a possibility that flow defects and filling defects of resin will occur in the mold.

### Flame Retardant

(Phosphinic Acid Salt and/or Disphosphinic Acid Salt)

The phosphinic acid salt and/or disphosphinic acid salt is/are not particularly limited, and those that are conventional and well known can be used. One, two or more of these compounds are used in the resin composition containing the above-mentioned phosphorus-derived flame retardant. It should be noted that the above-mentioned phosphinic acid salt and the like correspond to flame retardants in the resin composition containing the above-mentioned phosphorus-derived flame retardant.

Among conventional, well-known phosphinic acid salts, phosphinic acid salts represented by the following general formula (1) are preferable. In addition, among conventional, well-known disphosphinic acid salts, disphosphinic acid salts represented by the formula (2) are preferable.

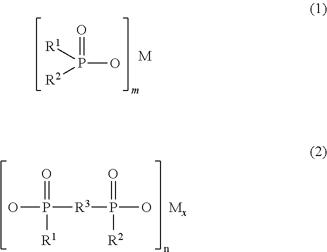

R¹ and R² in the above general formulae (1) and (2) are a phenyl group, hydrogen, or a straight or branched chain C₁-C₆. alkyl group that may contain one hydroxyl group. R¹ and R² are preferable both ethyl groups.

In addition, R³ is a straight or branched chain C₁-C₁₀ alkylene group, arylene group, alkylaryl group or arylalkylene group.

Furthermore, M is an alkali earth metal, alkali metal, Zn, Al, Fe, or boron. Among these, Al is preferable.

m is an integer of 1 to 3, n is an integer of 1 or 3, and x is 1 or 2.

Among the above-mentioned phosphinic acid salts and/or disphosphinic acid salts, using diethylphosphinic acid aluminum salt is particularly preferable.

These phosphinic acid salts and the like of the present invention are preferably contained in 10 to 100 parts by mass relative to 100 parts by mass of thermoplastic polyester resin, It is preferable if the content is at least 10 parts by mass for the reason that, stable flame retardance will be obtained, and it is preferable if the content is no more than 100 parts by mass for the reason of excelling in mechanical properties. It is more preferably 15 to 60 parts by mass,

### (Nitrogen-Derived Flame Retardant)

It is preferable to contain a conventional, well-known nitrogen-derived flame retardant in the resin composition containing the above-mentioned phosphorus-derived flame retardant. Among conventional, well-known nitrogen-derived flame retardants, a salt of cyanuric ester or isocyanuric ester and a triazine compound and/or a double salt of a nitrogen compound containing an amino group and polyphosphoric acid are preferable.

As the above-mentioned salt of a cyanuric ester or isocyanuric ester and a triazine compound, a salt of cyanuric ester or isocyanuric ester and a triazine compound represented by the following general formula (3) is exemplified as a preferable salt.

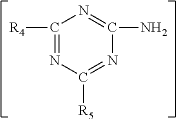

In the formula, R₄ and R₅ are a hydrogen atom, amino group, aryl group or C₁₋₃ oxyalkyl group, and R₄ and R₅ may be the same or different.

In the present invention, among the salts of cyanuric ester or isocyanuric ester and triazine compound represented by the above general formula (3), using melamine cyanurate is particularly preferable.

In addition, in the nitrogen compound containing an amino group included in a double salt of a nitrogen compound containing an amino group and polyphosphoric acid, a heterocyclic compound having at least one amino group and at least one nitrogen atom as a heteroatom of a heterocycle is included, and the heterocycle may have other heteroatoms other than nitrogen such as sulfur and oxygen. Such nitrogen-containing heterocycles include a 5 or 6-membered unsaturated nitrogen-containing heterocycle having a plurality of nitrogen atoms as constituent atoms thereof of the ring, such as imidazole, thiadiazole, thiadiazoline, furazan, triazole, thiadiazine, pyrazine, pyrimidine, pyridazine, triazine, and purine. Among such nitrogen-containing rings, a 5- or 6-membered unsaturated nitrogen-containing ring having a plurality of nitrogen atoms as constituent atoms of the ring is preferred, and in particular, triazole and triazine are preferred. Then, among the double salts of an amino group-containing nitrogen compound and polyphosphoric acid, melam polyphosphate is preferred.

In the resin composition containing the above-mentioned phosphorus-based flame retardant, the content of the above-mentioned nitrogen-based flame retardant is preferable 1 to 50 parts by mass relative to 100 parts by mass of the thermoplastic polyester resin. It is preferable if the content of the nitrogen-based flame retardant is 1 part by mass or higher for the reason of stable flame retardance being obtained, and it is preferable if no more than 50 parts by mass for the reason of excelling in the mechanical properties. More preferably, the content is 3 to 30 parts by mass relative to 100 parts by mass of thermoplastic polyester resin.

### Filler

It is preferable for the above-mentioned resin composition containing phosphorus-derived flame retardant to further contain a filler. The type of filler is not particularly limited, and although it may be either organic or inorganic, an inorganic filler is preferable. As conventional, well-known inorganic fillers, a fibrous filler, powder and granular fillers, plate-like filler or the like can be exemplified. In addition, two or more types of fillers may be contained in the above-mentioned resin composition containing a phosphorus-derived flame retardant.

As fibrous fillers, for example, inorganic fibrous substances such as glass fiber, asbestos fiber, silica fiber, silica-alumina fiber, alumina fiber, zirconia fiber, boron nitride fiber, silicon nitride fiber, boron fiber and potassium titanate fiber, and further, the fibrous form of metals such as stainless steel, aluminum, titanium, copper and brass can be exemplified.

As powder and granular fillers, carbon black, graphite, silicates like quartz powder, glass beads, milled glass fiber, glass balloons, glass powder, calcium silicate, aluminum silicate, kaolin, talc, clay, diatom earth and wollastonite, oxides of metals like iron oxide, titanium oxide, zinc oxide, antimony trioxide and alumina, carbonates of metals like calcium carbonate and magnesium carbonate, sulfates of metals like calcium sulfate and barium sulfate, other ferrites, silicon carbide, silicon nitride, boron nitride, various metal powders, and the like can be exemplified.

In addition, mica, glass flakes, various metallic foils, and the like can be exemplified as plate-like fillers. As the filler contained in the thermoplastic polyester resin composition used in the present invention, glass fiber is particularly preferable among the above mentioned conventional, well-known fillers.

As the glass fiber, any well-known glass fiber is preferably used, and is not dependent on the glass fiber diameter, shape such as cylinders, egg-shaped cross-section and elliptical cross-section, or length when used in production of chopped strands, roving and the like, and the method of glass cutting. Although the present invention is not limited to the type of glass, in terms of quality, it is preferable to use E glass or anticorrosion glass containing zirconium element in the composition.

In addition, with the object of improving the interface property between the filler and resin matrix, it is preferable to use a filler that has been surface treated by an organic treatment agent such as a silane compound or epoxy compound. As the silane compound or epoxy compound to be used on this filler, any well-known one can be preferable used, and the present invention does not depend on the silane compound or epoxy compound to be used in the surface treatment of the filler.

In a case of filler being contained in the above-mentioned resin composition containing a phosphorus-derived flame retardant, the content of the filler is preferably no more than 200 parts by mass relative to 100 parts by mass of the thermoplastic polyester resin. It is preferable if the content of the filler is no more than 200 parts by mass for the reason of the flowability during molding being superior. More preferably, the content of the filler is no more than 150 parts by mass relative to 100 parts by mass of the thermoplastic polyester resin.

Epoxy Compound and/or Carbodiimide Compound

The polyester resin composition may induce hydrolysis from hot water or steam, and the resin may degrade. Therefore, a reactive stabilizer may be added to the above-mentioned resin composition containing a phosphorus-derive flame retardant. The moist heat resistance and durability are improved, and degradation of the resin due to hydrolysis is suppressed, by the reactive stabilizer.

As the reactive stabilizer, a compound having at least one functional group selected from compounds having a cyclic ether group, anhydride group, isocyanate group, oxazoline group (cyclic), oxazine group (cyclic), epoxy group, carbodiimade group, or the like can be exemplified. Among these, a compound having an epoxy group (epoxy compound) and a compound having a carbodiimide group (carbodiimide compound) are preferably used due to reactivity with the polyester resin, ease of handling and ease of procurement.

As the epoxy compound, for example, an alicyclic compound such as vinylcyclohexene dioxide; a glycidyl ester compound such as glycidyl versatate; a glycidyl ether compound (hydroquinone diglycidyl ether, biphenol diglycidyl ether, bisphenol-A diglycidyl ether, etc.), a gylcidyl amine compound, an epoxy-containing vinyl copolymer (e.g., epoxidized polybutadiene, epoxidized diene-based monomer-styrene co-polymer, etc.), a triglycidyl isocyanurate, an epoxy-modified (poly)organosiloxane, and the like can be exemplified.

As the carbodiimide compound, for example, polyarylcarbodiimide such as a poly(phenylcarbodiimide) and a poly(naphthylcarbodiimide); a polyalkylarylcarbodiimide such as a poly(2-methyldiphenylcarbodiimide), a poly(2,6-diethyldiphenylcarbodiimide), a poly(2,6-diisopropyldiphenylcarbodiimade), a poly(2,4,6-triisopropyldiphenylcarbodiimide), and a poly(2,4,6-tri-t-butyldiphenylcarbodiimide); a poly[alkylenebis(alkyl or cycloalkylaryl)carbodiimide] such as a poly[4,4′-methylenebis(2,6-diethylphenyl)carbodiimide], a poly[4,4′-methylenebis(2-ethyl-6-methylphenyl)carbodiimide], a poly[4,4′-methylenebis(2,6-diisopropylphenyl)carbodiimide], and a poly[4,4′-methy enebis(2-ethyl-6-methylcyclohexylphenyl)carbodiimide]; and the like can be exemplified.

The epoxy compound and carbodiimide compound can be used independently or by combining two or more.

In addition, the carbodiimide compound can also be blended as a master batch with resin as a matrix, and using a master batch is often easy from the aspect of actual handling. Although a master batch from a polyester resin is ideally used, it is allowable to use the composition prepared from other resins as the master batch. In the case of being a master batch from a polyester resin, it is only necessary to adjust so as to be within a predetermined range of blending amount. Upon melting and kneading, the master batch is charged in advance, and may be made into uniform pellets. In addition, components other than the carbodiimide compound are made into uniform pellets by melting and kneading or the like in advance, and may be used in molding a pellet blended article in which master batch pellets of carbodiimide compound were dry blended during molding.

The content in a case of containing epoxy compound and/or carbodiimide compound in the above-mentioned resin composition containing phosphorus-derived flame retardant is preferable 0.1 to 10 parts by mass relative to 100 parts by mass of the thermoplastic polyester resin. It is preferable if the content of epoxy compound and/or carbodiimide compound is at least 0.1 parts by mass for the reason of excelling in hydrolysis resistance and the electrical property stabilizing, and it is preferable if no more than 10 parts by mass for the reason of excelling in flowability during molding. More preferably, the content of epoxy compound and/or carbodiimide compound is 0.5 to 8 parts by mass relative to 100 parts by mass of the thermoplastic polyester resin.

### Flame Retardant Additive

A flame retardant additive may be contained in the above-mentioned phosphorus-derived flame retardant resin composition, as necessary. The flame retardant additives that can be contained are not particularly limited, and a conventional, well-known one can be used.

### Other Components

A composition imparted with a desired property may also be contained in the above-mentioned resin composition containing a phosphorus-derived flame retardant, by adding other resins, nucleating agent, pigments such as carbon black and an inorganic firing pigment, or an added agent such as an antioxidant, a stabilizer, a plasticizer, a lubricant, a mold released agent, a dripping inhibitor, a flame retardant, or the like. For example, as the dripping inhibitor during firing, and as a tracking resistance enhancer, it is preferably to jointly use a fluorine-containing resin. A homo- or co-polymer of a fluorine-containing monomer, e.g., a homo- or co-polymer of the fluorine-containing monomers (tetrafluoroethylene, chlorotrifluoroethylene, vinylidene fluoride, hexafluoropropylene, perfluoroalkyl vinyl ether, etc.), or a co-polymer of the fluorine-containing monomer and another copolymerizable monomer (olefinic monomers such as ethylene and propylene, acrylic monomers such as (meta)acrylate, etc.), or the like are contained in the fluorine-containing resin. In the above-mentioned resin composition containing a phosphorus-derived flame retardant, tetrafluoroethylene polymer is particularly preferable due to ease of procurement, effectiveness, and ease of handling. The content of tetrafluoroethylene polymer relative to 100 parts by mass of the thermoplastic polyester resin can be selected from the range of about 0.1 to 50 parts by mass, and preferably 0.5 to 20 parts by mass.

In the production of the resin composition to be used in the present invention, it is possible to simply produce using equipment and methods commonly used as a conventional resin composition production method. For example, it is possible to employ any of 1) a method of mixing each component, then producing pellets by kneading and extruding by way of a single-screw or twin-screw extruder, and subsequently molding; 2) a method of producing pellets of different composition, mixing these pellets in predetermined amounts and supplying for molding, and obtaining a molded article of the objective composition after molding; and 3) a method of directly charging each of one, two or more components into a molding machine. In addition, a method of making a portion of the resin components to be fine powder, and adding by mixing with components other than this is a preferable method due to achieving uniform blend of these components.

### Resin Composition Containing Talc

The resin composition containing talc contains a thermoplastic polyester resin, flame retardant and talc. As described later, the content of talc is preferably 30 to 100 parts by mass relative to 100 parts by mass of the thermoplastic polyester resin.

### Thermoplastic Polyester Resin

As the thermoplastic polyester resin contained in the above-mentioned resin composition containing talc, resins similar to those explained for the above-mentioned resin composition containing a phosphorus-derived flame retardant can be exemplified. In addition, similarly to the case of the above-mentioned resin composition containing a phosphorus-derived flame retardant, polybutylene terephthalate resin, modified polybutylene terephthalate resin, polyethylene terephthalate resin, modified polyethylene terephthalate resin, or a mixture of these is preferable as the thermoplastic polyester resin. Among these, polybutylene terephthalate resin is particularly preferable.

### Flame Retardant

The type of flame retardant used in the above-mentioned resin composition containing talc is not particularly limited, and a conventional, well-known flame retardant can be used. As conventional, well-known flame retardants, for example, a halogen flame retardant, metal salts of inorganic acids, silicone flame retardant, antimony flame retardant, nitrogen flame retardant and the like can be exemplified. These flame retardants can be used independently or by combining two or more types.

Among halogen flame retardants, the use of a brominated flame retardant in the above-mentioned resin composition containing talc is particularly preferable. As the brominated flame retardant, a bromine-containing acrylic resin (e.g., brominated polybenzyl(meth)acrylate resin), bromine-containing styrene resin (e.g., bromination product of a styrene resin, brominated styrene resin such as a homo- or co-polymer of brominated styrene monomers, etc.), bromine-containing polycarbonate resin (brominated bisphenol-type polycarbonate resin, etc.), bromine-containing epoxy compound (brominated bisphenol-type epoxy resin, brominated bisphenol-type phenoxy resin, etc.) brominated polyaryl ether compound, brominated aromatic imide compound (e.g., alkylene-bis-brominated phthalimide (e.g., ethylene-bis-brominated phthalimide, etc.) etc.), brominated bisaryl compound, brominated tri(aryloxy)triazine compound, and the like can be exemplified. Among these brominated flame retardants, the bromine-containing acrylic resin (e.g., brominated benzyl acrylate, etc.), bromine-containing styrene resin, bromine-containing polycarbonate resin, and bromine-containing epoxy resin are particularly preferable.

As the inorganic acid constituting the salt in the metal salts of inorganic acids, phosphoric acid, sulfuric acid, boric acid, chromic acid, antimonic acid, a halogen acid, carbonic acid and the like are exemplified. In addition, as the metal constituting the salt with the organic acid, metals such as alkali metals, alkali earth metals, and transition metals are exemplified.

The content of flame retardant in the above-mentioned resin composition containing talc is preferably 3 to 50 parts by mass relative to 100 parts by mass of the thermoplastic polyester resin. It is preferable if the content of the flame retardant is at least 3 parts by mass for the reason that a stable flame retardance is obtained, and it is preferable if no more than 50 parts by mass for the reason of the mechanical properties being superior. More preferably, the content of the flame retardant is 5 to 40 parts by mass relative to the 100 parts by mass of the thermoplastic polyester resin.

### Talc

If talc is contained in the thermoplastic polyester resin composition, the tracking resistance can be improved in particular. Particularly when compacted fine powder talc is used as the talc, the uniform dispersibility rises, whereby it is possible to improve the kneading workability and mechanical properties.

A common talc may be used as the talc employed in the above-mentioned resin composition containing talc; however, it is preferable to use compacted fine powder talc. Among compacted fine powder talc, that having a bulk specific gravity of 0.4 to 1.5 is preferable. More preferably, the bulk specific gravity is 0.5 to 1.2. The average particle size of the compacted fine powder talc, for example, is preferably at least 150 μm, and is more preferably 150 to 300 μm.

The compacted fine powder talc is obtained by a conventional, well-known method such as a method of initial degassing the gas present in particles and between particles (e.g., air or the like) using a vacuum unit, and further removing remaining gas by way of the compressive force of a roller.

The average particle size of talc prior to compacting the compacted fine powder talc is preferably 0.04 to 10 μm, for example. More preferably, the average particle size is 0.5 to 5 μm. In addition, the bulk specific gravity of the talc prior to compacting is preferably 0.1 to 0.4. The amount of gas component contained in the compacted fine powder talc compared to the amount of gas component contained in the talc prior to compacting is preferably small, being at least 30% by volume (e.g., on the order of 30 to 95% by volume, preferably 30 to 80% by volume). It should be noted that the average particle size is obtained as the D50 value in a particle size distribution measurement conforming with JIS Z8820 and Z8822. In addition, the bulk specific gravity is obtained as the weight (g number) per 1 cm³ when filled into a volume having a fixed capacity.

The content of talc used in the above-mentioned resin composition containing talc is not particularly limited, and the content thereof is preferably 30 to 100 parts by mass relative to 100 parts by mass of the thermoplastic polyester resin. It is preferable if the content of talc is at least 30 parts by mass for the reason that the tracking resistance is superior, and it is preferable if the content of talc is no more than 100 parts by mass for the reason of excelling in mechanical properties. More preferably, the content of talc is 35 to 80 parts by mass relative to 100 parts by mass of the thermoplastic polyester resin.

### Olefinic Elastomer

It is preferable to contain an olefinic elastomer in the above-mentioned resin composition containing talc. The characteristic of an olefinic elastomer can be effectively realized by combining the thermoplastic polyester resin, flame retardant and talc with an olefinic elastomer, whereby mechanical properties such as toughness and impact resistance in particular can be greatly improved.

A conventional, well-known olefinic elastomer can be used in the above-mentioned resin composition containing talc, As conventional, well-known olefinic elastomers, for example, an ethylene-propylene co-polymer (EP co-polymer), an ethylene-propylene-diene co-polymer (EPD co-polymer), a copolymer containing at least one unit selected from EP co-polymer and EPD co-polymer, a co-polymer of olefin and (meth)acrylic monomer, and the like are included. EP co-polymer, EPD co-polymer, and a co-polymer of olefin and (meth)acrylic monomer are preferably included in the olefinic elastomer. The olefinic elastomer can be used independently or by combining two or more types.

As the olefinic elastomer used in the above-mentioned resin composition containing talc, ethylene ethyl acrylate is particularly preferable.

Although the content of olefinic elastomer is not particularly limited, it is preferably 5 to 50 parts by mass relative to 100 parts by mass of the thermoplastic polyester resin. It is preferable if the content of olefinic elastomer is at least 5 parts by mass for the reason of excelling in toughness and the molded article not easily braking. More preferably, the content of olefinic elastomer is 8 to 30 parts by mass.

### Filler

The above-mentioned resin composition containing talc preferably contains a filler. As the filler contained in the above-mentioned resin composition containing talc, the same ones as those explained in the above-mentioned resin composition containing a phosphorus-derived flame retardant can be exemplified. In addition, as the filler used, glass fiber is preferable, similarly to the case of the above-mentioned resin composition containing a phosphorus-derived flame retardant. The preferred content of filler is also the same as the case of the above-mentioned resin composition containing a phosphorus-derived flame retardant.

### Flame Retardant Additive

A conventional, well-known flame retardant additive may be included in the above-mentioned resin composition containing talc as required.

In a case of using a brominated flame retardant as the flame retardant, it is preferable to use an antimony-containing compound as the flame retardant additive.

As the antimony-containing compound, for example, antimony trioxide, antimony pentoxide, antimonite and the like can be exemplified. These antimony-containing compounds can be used independently or by combining two or more types. Among the antimony-containing compounds, antimony trioxide is preferred. The content of antimony trioxide relative to 100 parts by mass of the thermoplastic polyester resin, for example, can be selected from the range of 1 to 30 parts by mass, and preferably 3 to 20 parts by mass.

### Fluorine-Containing Resin

The above-mentioned resin composition containing talc preferably jointly uses a fluorine-containing resin as a dripping inhibitor during firing, and as a tracking resistance enhancer, As the fluorine-containing resin, the same ones as in the above-mentioned resin composition containing a phosphorus-derived flame retardant such as tetrafluoroethylene polymer can be used.

Epoxy Compound and/or Carbodiimide Compound

As the epoxy compounds and carbodiimide compounds, the same ones as in the above-mentioned resin composition containing a phosphorus-derived flame retardant can be used in the above-mentioned resin composition containing talc.

### Case Storing Electric Vehicle Parts

A molded article for electric vehicle parts of the present invention has superior flame retardance and superior tracking resistance, while having superior electric insulation.

Superior flame retardance is a flame retardance level “V-0” according to the UL standard 94.

Superior tracking resistance is tracking occurring in a test piece at an applied voltage of no less than 500 V in a tracking resistance test performed by the method described in the Examples later.

Superior electric insulation is a volume resistivity value of at least 1×10¹⁵ Ω·m after a Pressure Cooker Test (PCT) described in the Examples.

In addition, superior heat resistance is also exhibited by using the technology of the present invention and, for example, it is possible to reach no less than 500 V in the tracking resistance test even after heat treatment at 180° C. for 200 hours.

It is possible to impart extremely superior flame retardance, tracking resistance and electric insulation to the molded article by containing the aforementioned preferred components in preferred amounts in the thermoplastic polyester resin composition used in the present invention.

The electric vehicle parts to be stored in the case of the present invention are not particularly limited; however, the above-mentioned thermoplastic polyester resin composition is preferred as the material for a case storing a power module, step-down DC/DC converter, step-up DC/DC converter, capacitor, insulator, motor terminal block, battery, electric compressor, battery current sensor and junction block, and the like.

The storage case for electric vehicle parts according to the present invention is molded by way of a conventional, well-known method. As the conventional, well-known method, for example, injection molding, injection compression molding, gas-assisted injection molding, extrusion molding, multi-layer extrusion molding, rotational molding, hot press molding, blow molding, expansion molding and the like can be exemplified.

### EXAMPLES

Although the present invention will be explained in detail based on Examples and Comparative Examples hereinafter, the present invention is to be in no way limited by these Examples.

### Materials

Polyester resin 1: polybutylene terephthalate resin, IV=0.69, terminal carboxyl group amount 25 meq/kg (manufactured by WinTech Polymer Ltd.)

Polyester resin 2: polyethylene terephthalate resin, IV=0.76, terminal carboxyl group amount 21 meq/kg (manufactured by SK Chemicals Co., Ltd.)

Polyester resin 3: polybutylene terephthalate resin, 1V=0.69, terminal carboxyl group amount 53 meq/kg (manufactured by WinTech Polymer Ltd.)

Phosphinic acid salt: diethylphosphinic acid aluminum salt, “Exolit OP 1230” (manufactured by Clariant)

Nitrogen-derived flame retardant 1: melamine cyanurate, “Melapure50” (manufactured by DSM)

Nitrogen-derived flame retardant 2 melamine polyphosphate, “Melapure200” (manufactured by DSM)

Talc: compacted fine powder talc, average particle size 2.7 μm (measured as numerical value of D50 with an SA-CP3L particle size analyzer manufactured by Shimadzu Corporation), bulk specific gravity 0.9, “UPN HS-T” (manufactured by Hayashi Kasei Co., Ltd.)

Filler: glass fiber, “CS3J948S” (manufactured by Nitto Boseki Corp.)

Tetrafluoroethylene polymer: “PTF850A” (manufactured by Mitsui DuPont Fluorochemical, Co.)

Brominated flame retardant 1: brominated benzyl acrylate, “FR-1025” (manufactured by ICL-IP)

Brominated flame retardant 2: brominated epoxy resin, “SRT5000” (manufactured by Sakamoto Yajuhin Kogyo Co., Ltd.)

Brominated flame retardant 3: brominated polycarbonate, “FG-7500” (manufactured by Teijin Chemicals, Ltd.)

Brominated flame retardant brominated polystyrene, “Pyrocheck 68PB” (manufactured by Albemarle Japan Corp.)

Phosphorus-derived flame retardant 1: phosphate ester, “PX-200” (manufactured by Daihachi Chemical)

Phosphorus-derived flame retardant 2: red phosphorus, “NVE140” (manufactured by Rinkagaku Kogyo Co., Ltd.)

Antimony-derived flame retardant: antimony trioxide, “PATOX-M” (manufactured by Nihon Seiko Co., Ltd.)

Olefinic elastomer: ethylene ethyl acrylate, “NUC-6570” (manufactured by Nippon Unicar Co., Ltd.)

Epoxy compound: “Epicoat 1004” (manufactured by Yuka Shell Epoxy Co., Ltd.)

Carbodiimide compound: “Stabaxol P” (manufactured by Rhein Chemie Japan, Co., Ltd.)

### Examples and Comparative Examples

After weighing, the components shown in Tables 1 and 2 were dry blended, and then melt kneaded using a 30-mm diameter twin screw extruder (“TEX-30” manufactured by Japan Steel Works, Ltd.) to prepare pellets (sintering temperature 260° C., discharge rate 15 kg/h, screw rotation speed 150 rpm).

TABLE 1

| | | | | | | | Compar- | Compar- | Compar- | Compar- | Compar- | Compar- |
|---|---|---|---|---|---|---|---|---|---|---|---|---|
| | | | | | | | ative | ative | ative | ative | ative | ative |
| | Exam- | Exam- | Exam- | Exam- | Exam- | Exam- | Exam- | Exam- | Exam- | Exam- | Exam- | Exam- |
| | ple 1 | ple 2 | ple 3 | ple 4 | ple 5 | ple 6 | ple 1 | ple 2 | ple 3 | ple 4 | ple 5 | ple 6 |
| Polyester resin1 | 100 | 100 | 49 | 100 | 100 | 100 | 100 | | 100 | 100 | 100 | 100 |
| (parts by mass) | | | | | | | | | | | | |
| Polyester resin2 | | | 51 | | | | | | | | | |
| (parts by mass) | | | | | | | | | | | | |
| Polyester resin3 | | | | | | | | 100 | | | | |
| (parts by mass) | | | | | | | | | | | | |
| Phosphinic acid | 18 | 41 | 41 | 33 | 41 | 41 | | 41 | | | | |
| salt (parts by mass) | | | | | | | | | | | | |
| Nitrogen-derived | | | | 17 | | | | | | | | 18 |
| flame retardant 1 | | | | | | | | | | | | |
| (parts by mass) | | | | | | | | | | | | |
| Nitrogen-derived | | | | | | | | | | 20 | | |
| flame retardant 2 | | | | | | | | | | | | |
| (parts by mass) | | | | | | | | | | | | |
| Filler(parts by mass) | | 61 | 61 | 65 | 61 | 61 | | 61 | 56 | 73 | 49 | |
| Tetrafluoroethylene | 1 | 2 | 2 | 2 | 2 | 2 | | 2 | 2 | 2 | 2 | 1 |
| polymer | | | | | | | | | | | | |
| (parts by mass) | | | | | | | | | | | | |
| Brominated flame | | | | | | | | | 19 | | | |
| retardant1 | | | | | | | | | | | | |
| (parts by mass) | | | | | | | | | | | | |
| Antimony-derived | | | | | | | | | 9 | | | |
| flame retardant | | | | | | | | | | | | |
| (parts by mass) | | | | | | | | | | | | |
| Phosphorus- | | | | | | | | | | 49 | | |
| derived flame | | | | | | | | | | | | |
| retardant1 | | | | | | | | | | | | |
| (parts by mass) | | | | | | | | | | | | |
| Phosphorus- | | | | | | | | | | | 13 | |
| derived flame | | | | | | | | | | | | |
| retardant2 | | | | | | | | | | | | |
| (parts by mass) | | | | | | | | | | | | |
| Epoxy compound | | | | | 2 | | | | | | | |
| (parts by mass) | | | | | | | | | | | | |
| Carbodiimide | | | | | | 2 | | | | | | |
| compound | | | | | | | | | | | | |
| (parts by mass) | | | | | | | | | | | | |

TABLE 2

| | | | | | | | | | Compar- | Compar- | Compar- | Compar- |
|---|---|---|---|---|---|---|---|---|---|---|---|---|
| | | | | | | | | | ative | ative | ative | ative |
| | Exam- | Exam- | Exam- | Exam- | Exam- | Exam- | Exam- | Exam- | Exam- | Exam- | Exam- | Exam- |
| | ple 7 | ple 8 | ple 9 | ple 10 | ple 11 | ple 12 | ple 13 | ple 14 | ple 7 | ple 8 | ple 9 | ple 10 |
| Polyester resin1 | 100 | 100 | 100 | 100 | 100 | 100 | 100 | 100 | | 100 | 100 | 100 |
| (parts by mass) | | | | | | | | | | | | |
| Polyester resin3 | | | | | | | | | 100 | | | |
| (parts by mass) | | | | | | | | | | | | |
| Brominated flame | 20 | 14 | 14 | | | | 14 | 14 | 14 | 9 | 11 | 12 |
| retardant1 | | | | | | | | | | | | |
| (parts by mass) | | | | | | | | | | | | |
| Antimony-derived | 10 | 6 | 6 | 6 | 6 | 7 | 6 | 6 | 6 | 4 | 5 | 5 |
| flame retardant | | | | | | | | | | | | |
| (parts by mass) | | | | | | | | | | | | |
| Talc(parts by mass) | 71 | 51 | 41 | 51 | 51 | 44 | 51 | 51 | 51 | | 16 | 25 |
| Filler(parts by mass) | | 31 | 31 | 31 | 31 | 33 | 31 | 31 | 31 | 20 | 23 | 25 |
| Tetrafluoroethylene | 2 | 2 | 2 | 2 | 2 | 11 | 2 | 2 | 2 | 1 | 2 | 2 |
| polymer | | | | | | | | | | | | |
| (parts by mass) | | | | | | | | | | | | |
| Olefinic | | | 10 | | | 11 | | | | | | |
| elastomer | | | | | | | | | | | | |
| (parts by mass) | | | | | | | | | | | | |
| Brominated flame | | | | 14 | | | | | | | | |
| retardant2 | | | | | | | | | | | | |
| (parts by mass) | | | | | | | | | | | | |
| Brominated flame | | | | | 14 | | | | | | | |
| retardant3 | | | | | | | | | | | | |
| (parts by mass) | | | | | | | | | | | | |
| Brominated flame | | | | | | 16 | | | | | | |
| retardant4 | | | | | | | | | | | | |
| (parts by mass) | | | | | | | | | | | | |
| Epoxy compound | | | | | | | 2 | | | | | |
| (parts by mass) | | | | | | | | | | | | |
| Carbodiimide | | | | | | | | 2 | | | | |
| compound | | | | | | | | | | | | |
| (parts by mass) | | | | | | | | | | | | |

The pellets thus obtained were charged into an injection molding machine (“H180AP” manufactured by Japan Steel Works, Ltd.) to manufacture a case for storing a capacitor under the following molding conditions. The dimensions of the case thus obtained were 110 mm length×110 mm width×40 mm height, and 1.6 mm thick.

### Molding Conditions

Sintering temperature: 260° C.
Mold temperature: 60° C.
Injection rate: 30 mm/s
Hold pressure: 70 MPa×30 s
Cooling time 25 s
Screw rotation speed: 100 rpm

### Backpressure: 5 MPa

A test sample required for evaluating physical properties by the test described below was cut out from the above-mentioned case, and evaluation of the flame retardance, tracking resistance, and volume resistivity value was performed. The evaluation results are shown in Tables 3 and 4.

(1) Flame Retardance Test

The flame retardance was evaluated with the test sample of 125 mm length×13 mm width×1.6 mm thickness, based on UL94.

(2) Tracking Resistance Test

Using a 0.1% ammonium chloride aqueous solution and platinum electrode, the applied voltage at which tracking occurred in the test sample was measured based on IEC (International Electrotechnical Commission) 112/3. A test sample after heat treatment at 180° C. for 200 hours, and a test sample after pressure cooker treatment (hereinafter PCT test) for 200 hours with 120° C. saturated steam were measured for tracking resistance

(3) Pressure Cooker Test (PCT)

Using resin compositions obtained in the Examples and

Comparative Examples, test samples of 50 mm length×50 mm width×1.6 mm thick were exposed for 200 hours in a pressure cooker test apparatus under 120° C. saturated steam at 0.2 MPa.

(4) Volume Electrical Resistivity

A test strip after the pressure cooker test was set in a resistivity chamber (main electrode: 50 mm diameter, guard electrode: I.D 70 mm/O.D. 80 mm, opposite electrode: 103 mm diameter), this was measured for resistance value with a tester or ultra high resistance meter, and the volume resistivity was calculated. It should be noted that the measurement of the volume resistivity value was performed only for test samples after the above-mentioned PCT treatment.

TABLE 3

| | | | | | | | Compar- | Compar- | Compar- | Compar- | Compar- | Compar- |
|---|---|---|---|---|---|---|---|---|---|---|---|---|
| | | | | | | | ative | ative | ative | ative | ative | ative |
| | Exam- | Exam- | Exam- | Exam- | Exam- | Exam- | Exam- | Exam- | Exam- | Exam- | Exam- | Exam- |
| | ple 1 | ple 2 | ple 3 | ple 4 | ple 5 | ple 6 | ple 1 | ple 2 | ple 3 | ple 4 | ple 5 | ple 6 |
| UL94 Flame | V0 | V0 | V0 | V0 | V0 | V0 | HB | V0 | V0 | V0 | V2 | V2 |
| Retardance | | | | | | | | | | | | |
| Determination | | | | | | | | | | | | |
| Tracking | 600 | 600 | 600 | 600 | 600 | 600 | 600 | 600 | 275 | 250 | 250 | 600 |
| resistance when | | | | | | | | | | | | |
| untreated (V) | | | | | | | | | | | | |
| Tracking | 600 | 600 | 600 | 600 | 600 | 600 | 450 | 600 | 275 | 200 | 200 | 450 |
| resistance | | | | | | | | | | | | |
| after 180° C., | | | | | | | | | | | | |
| 200 hour | | | | | | | | | | | | |
| treatment(V) | | | | | | | | | | | | |
| Tracking | 600 | 600 | 600 | 600 | 600 | 600 | 450 | 400 | 275 | 200 | 200 | 475 |
| resistance | | | | | | | | | | | | |
| after PCT | | | | | | | | | | | | |
| treatment | | | | | | | | | | | | |
| (120° C., | | | | | | | | | | | | |
| saturated | | | | | | | | | | | | |
| steam, 200 | | | | | | | | | | | | |
| hours) (V) | | | | | | | | | | | | |
| Volume | 6.9 × | 7.5 × | 6.2 × | 5.6 × | 8.0 × | 8.4 × | 7.7 × | 1.1 × | 5.8 × | 2.5 × | 4.6 × | 5.1 × |
| resistivity | 10¹⁶ | 10¹⁶ | 10¹⁶ | 10¹⁶ | 10¹⁶ | 10¹⁶ | 10¹⁶ | 10¹⁶ | 10¹⁶ | 10¹¹ | 10⁹ | 10¹⁶ |
| value after | | | | | | | | | | | | |
| PCT treatment | | | | | | | | | | | | |
| (120° C., | | | | | | | | | | | | |
| saturated | | | | | | | | | | | | |
| steam, 120 | | | | | | | | | | | | |
| hours) (Ω · m) | | | | | | | | | | | | |

TABLE 4

| | | | | | | | | | Compar- | Compar- | Compar- | Compar- |
|---|---|---|---|---|---|---|---|---|---|---|---|---|
| | | | | | | | | | ative | ative | ative | ative |
| | Exam- | Exam- | Exam- | Exam- | Exam- | Exam- | Exam- | Exam- | Exam- | Exam- | Exam- | Exam- |
| | ple 7 | ple 8 | ple 9 | ple 10 | ple 11 | ple 12 | ple 13 | ple 14 | ple 7 | ple 8 | ple 9 | ple 10 |
| UL94 Flame | V0 | V0 | V0 | V0 | V0 | V0 | V0 | V0 | V0 | V0 | V0 | V0 |
| Retardance | | | | | | | | | | | | |
| Determination | | | | | | | | | | | | |
| Tracking | 600 | 600 | 600 | 600 | 600 | 600 | 600 | 600 | 600 | 250 | 350 | 400 |
| resistance when | | | | | | | | | | | | |
| untreated (V) | | | | | | | | | | | | |
| Tracking | 600 | 600 | 600 | 600 | 600 | 600 | 600 | 600 | 600 | 250 | 350 | 400 |
| resistance | | | | | | | | | | | | |
| after 180° C., | | | | | | | | | | | | |
| 200 hour | | | | | | | | | | | | |
| treatment(V) | | | | | | | | | | | | |
| Tracking | 600 | 600 | 600 | 600 | 600 | 600 | 600 | 600 | 450 | 250 | 350 | 400 |
| resistance | | | | | | | | | | | | |
| after PCT | | | | | | | | | | | | |
| treatment | | | | | | | | | | | | |
| (120° C., | | | | | | | | | | | | |
| saturated | | | | | | | | | | | | |
| steam, 200 | | | | | | | | | | | | |
| hours) (V) | | | | | | | | | | | | |
| Volume | 5.6 × | 7.2 × | 6.6 × | 6.4 × | 7.0 × | 4.1 × | 8.8 × | 7.9 × | 2.3 × | 6.3 × | 7.8 × | 7.5 × |
| resistivity | 10¹⁶ | 10¹⁶ | 10¹⁶ | 10¹⁶ | 10¹⁶ | 10¹⁶ | 10¹⁶ | 10¹⁶ | 10¹⁶ | 10¹⁶ | 10¹⁶ | 10¹⁶ |
| value after | | | | | | | | | | | | |
| PCT treatment | | | | | | | | | | | | |
| (120° C., | | | | | | | | | | | | |
| saturated | | | | | | | | | | | | |
| steam, 120 | | | | | | | | | | | | |
| hours) (Ω · m) | | | | | | | | | | | | |

As is evident from the results of Tables 3 and 4, the case made by molding the thermoplastic polyester resin composition of the present invention simultaneously has excellent flame retardance, tracking resistance and electric insulation. It has been confirmed that the tracking resistance in particular could be maintained at a high value even after heat treatment and pressure cooker treatment under saturated steam. Then, also for electric insulation, it has been confirmed from the volume resistivity that superior electric insulation is exhibited even after pressure cooker treatment under saturated steam.

1-15. (canceled)

16. A molded article for an electric vehicle part formed by molding a thermoplastic polyester resin composition, comprising a thermoplastic polyester resin, having a terminal carboxyl group amount that is no more than 30 meq/kg, and a flame retardant,
wherein the tracking resistance measured according to IEC 112, the third edition, after pressurized heat treatment with the 120° C. saturated steam for 200 hours is at least 500 V, and
wherein the volume resistivity value measured after the pressurized heat treatment with the 120° C. saturated steam for 200 hours is no less than 1×10¹⁵ Ω·m.

17. The molded article for an electric vehicle part according to claim 1, wherein the flame retardant is phosphinic acid salt and/or diphosphinic acid salt, and is contained in an amount of 10 to 100 parts by mass relative to 100 parts by mass of the thermoplastic polyester resin.

18. The molded article for an electric vehicle part according to claim 17, wherein the phosphinic acid salt is represented by the following general formula (1), and the diphosphinic acid salt is represented by the following general formula (2) 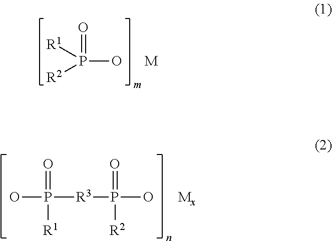
wherein, in the formulae, R¹ and R² are a linear or branched C₁ to C₆-alkyl group which may contain a phenyl group, hydrogen or one hydroxyl group, R³ is a linear or branched C₁˜C₁₀-alkylene group, arylene group, alkylarylene group or arylalkylene group; M is an alkaline earth metal, alkaline metal, Zn, Al, Fe or boron; m is an integer of 1 to 3; n is an integer of 1 or 3; and x is 1 or 2.

19. The molded article for an electric vehicle part according to claim 17, further comprising 1 to 50 parts by mass of a salt of a triazine-derived compound and cyanuric acid or isocyanuric acid and/or a double salt of an amino-group-containing nitrogen compound and polyphosphoric acid, as a nitrogen-derived flame retardant, relative to 100 parts by mass of the thermoplastic polyester resin.

20. The molded article for an electric vehicle part according to claim 18, further comprising 1 to 50 parts by mass of a salt of a triazine-derived compound and cyanuric acid or isocyanuric acid and/or a double salt of an amino-group-containing nitrogen compound and polyphosphoric acid, as a nitrogen-derived flame retardant, relative to 100 parts by mass of the thermoplastic polyester resin.

21. The molded article for an electric vehicle part according to claim 16, further comprising 30 to 100 parts by mass of talc relative to 100 parts by mass of the thermoplastic polyester resin.

22. The molded article for electric vehicle parts according to claim 21, wherein the flame retardant is at least one kind selected from the group consisting of a brominated flame retardant, phosphorus-derived flame retardant, antimony-derived flame retardant and nitrogen-derived flame retardant.

23. The molded article for an electric vehicle part according to claim 21, wherein the talc has an average particle diameter of 0.04 to 10 μm and a bulk specific gravity of 0.4 to 1.5.

24. The molded article for an electric vehicle part according to claim 22, wherein the talc has an average particle diameter of 0.04 to 10 and a bulk specific gravity of 0.4 to 1.5.

25. The molded article for an electric vehicle part according to claim 20, wherein the molded article further comprises 5 to 50 parts by mass of an olefinic elastomer relative to 100 parts by mass of the thermoplastic polyester resin.

26. The molded article for an electric vehicle part according to claim 16, wherein the thermoplastic polyester resin is a polybutylene terephthalate resin, modified polybutylene terephthalate resin, polyethylene terephthalate resin, modified polyethylene terephthalate resin, or a mixture thereof.

27. The molded article for an electric vehicle part according to claim 16, further comprising a filler in an amount of no more than 200 parts by mass relative to 100 parts by mass of the thermoplastic polyester resin.

28. The molded article for an electric vehicle part according to claim 16, further comprising 0.1 to 50 parts by mass of tetrafluoro-ethylene polymer relative to 100 parts by mass of the thermoplastic polyester resin.

29. The molded article for an electric vehicle part according to claim 16, further comprising 0.1 to 10 parts by mass of an epoxy compound and/or a carbodiimide compound relative to 100 parts by mass of the thermoplastic polyester resin.

30. The molded article for an electric vehicle part according to claim 16, wherein the molded article is a case that stores the electric vehicle part.
